(19) United States
(12) Patent Application Publication
(10) Pub. No.: US 2025/0089727 A1
(43) Pub. Date: Mar. 20, 2025

(54) Conveyor Tunnel Oven

(71) Applicant: Wolfe Electric, Inc., Wichita, KS (US)

(72) Inventors: Chad Jones, Wichita, KS (US); Justin Strodtman, Wichita, KS (US)

(73) Assignee: Wolfe Electric, Inc., Wichita, KS (US)

(21) Appl. No.: 18/969,821

(22) Filed: Dec. 5, 2024

Related U.S. Application Data
(63) Continuation-in-part of application No. 18/763,308, filed on Jul. 3, 2024.
(60) Provisional application No. 63/642,164, filed on May 3, 2024.

(51) Int. Cl. A21B 1/48; A21B 3/00

(52) U.S. Cl. CPC A21B 1/48; A21B 3/00

(57) ABSTRACT

A conveyor tunnel oven incorporating a baking chamber having a longitudinal and an oppositely longitudinal ends; a food item intake and output ports opening the baking chamber at the baking chamber's longitudinal and oppositely longitudinal ends; a food conveyor extending through the baking chamber, the food conveyor having a longitudinal and oppositely longitudinal ends extending from the food intake and output ports; a longitudinal plurality of auxiliary baking chambers including a first longitudinal auxiliary baking chamber, and at least a second longitudinal auxiliary baking, the first longitudinal auxiliary baking chamber having a longitudinal dimension greater than that of the at least second longitudinal auxiliary baking chamber; and a longitudinal mounting plate attaching the longitudinal plurality of auxiliary baking chambers to the baking chamber, the longitudinal mounting plate positioning the longitudinal plurality of auxiliary baking chambers over the food conveyor's longitudinal end.

### REFERENCE TO PREVIOUSLY FILED PATENT APPLICATIONS

The instant patent application constitutes a continuation in part of U.S. patent application Ser. No. 18/763,308 filed Jul. 3, 2024, and the instant application claims the benefit of the filing date of and priority from said '308 application. The instant patent application also claims the benefit of and priority from U.S. Provisional Patent Application No. 63/642,164 filed May 3, 2024. The inventors and applicant disclosed in said '308 and '164 applications are the same persons as the persons who are disclosed as the inventors and applicant of the instant application.

### FIELD OF THE INVENTION

The instant invention relates to tunnel ovens of the type which include a baking case or baking chamber which is opened by food item input and output ports. A continuous loop grate type food conveyor commonly extends through the oven's baking chamber, such conveyor's ends extending outwardly from said ports. Such tunnel ovens also commonly include cooking air impingement registers or ducts which overlie and/or underlie the central portion of the conveyor which extends through the oven's baking chamber. More particularly, the instant invention is related to adaptations of such conveyor tunnel ovens for varying the effective cooking or baking times applied by the oven to food items carried by the conveyer.

### BACKGROUND OF THE INVENTION

Conveyor adapted food baking tunnel ovens are known to include interior forced air registers or finger ducts which are adapted to direct jets of heated cooking air toward food items conveyed through the oven. The cooking times of such known and conventional conveyor tunnel ovens are typically altered or adjusted only by means of altering the conveyor's cycling speed.

In many instances, altering such oven's conveyor cycling speed to accommodate a food item type will temporarily interfere with use of the oven for cooking other types of food. For example, such oven's conveyor speed may be slowed to increase the cooking time applied by the oven to a relatively dense and slowly heated food item such as chicken wings. While such an oven operates with a reduced chicken wings accommodating conveyor cycling speed, the oven may not be used for baking less dense and more quickly heated food items, such as a thin crust pizzas. The increased cooking time applied by the oven to the chicken wings may, for example, undesirably result in burning of a thin crust pizza which is mistakenly introduced into the oven between chicken wing introductions.

To properly bake a thin crust pizza, the tunnel oven's conveyor speed may be increased, temporarily precluding use of the oven for cooking denser items such as chicken wings. Accordingly, in use of such conventional conveyor tunnel ovens, the time periods dedicated to utilization of the oven for cooking chicken wings give rise to a threat of mistakenly overcooked pizzas. In any event, the oven usage periods dedicated to cooking chicken wings may result in an undesirable delay in use of the oven for cooking thin crust pizzas. Conversely, resetting the oven's conveyor cycling speed to accommodate faster pizza cooking times may result in delays in use of the oven for baking more dense food items such as chicken wings, or may result in mistakenly undercooked chicken wings.

The instant inventive conveyor tunnel oven solves or ameliorates the problems, defects, and deficiencies of conventional conveyor tunnel ovens, as described above, by incorporating into the oven at its food input and/or food output port specialized auxiliary baking chambers, and by specially modifying baking chamber air registers to direct flows of heated air toward inner ends of such auxiliary baking chambers.

### BRIEF SUMMARY OF THE INVENTION

A first structural component of the instant inventive conveyor tunnel oven comprises a baking chamber or case having a longitudinal end wall and an oppositely longitudinal end wall, the baking chamber also having an upper ceiling or wall and a lower floor or wall. The baking chamber also has a rear wall and a front wall which is often configured as a removable access panel. The rear wall of the baking chamber often supports a fan or blower which draws heated cooking air from within the chamber, and which drives the air into an air plenum which supports a plurality of air emitting finger ducts or registers.

The instant inventive conveyor tunnel oven preferably further comprises rectangular and laterally oblongated food intake and food output ports which respectively open the baking chamber at the longitudinal and oppositely longitudinal end walls.

A further structural component of the instant inventive conveyer tunnel oven comprises a continuous loop grate type food conveyor which extends longitudinally through the baking chamber's interior space. Such conveyor preferably has a longitudinal end which extends longitudinally from the food intake port and has an oppositely longitudinal end which extends oppositely longitudinally from the food output port. In the preferred embodiment, the food conveyor has a lateral span or width which extends leftwardly and rightwardly commensurately with the lateral dimension of the food intake and food output ports.

A further structural component of the instant inventive conveyor tunnel oven comprises a longitudinal auxiliary baking chamber, and preferably further comprises an oppositely longitudinal auxiliary baking chamber. In the preferred embodiment, each auxiliary baking chamber is configured as an at least first downwardly opening “C” channel having open longitudinal and oppositely longitudinal ends. To form such at least first channels, each auxiliary chamber preferably comprises an upper ceiling or wall, and lateral and oppositely lateral walls fixedly attached to and extending downwardly from lateral and oppositely lateral edges of the upper ceilings, such lateral and oppositely lateral walls suitably being alternatively described as front and rear walls. In a preferred embodiment, the lateral widths of the auxiliary baking chambers are great enough to allow longitudinal passages therethrough of food items such as chicken wings contained within a baking pan. In such embodiment, the lateral width of each auxiliary baking chamber is less than the width of the conveyor, such width differential allowing portions of the conveyor extending either laterally or oppositely laterally from the auxiliary baking chamber to be simultaneously utilized for carriage of more quickly cooked food items such as pizzas. Accordingly, in the preferred embodiment, the lateral widths of the conveyor and the food passage ports exceed the lateral widths of the auxiliary baking chambers by a distance at least as great as the diameter of a pizza, such width differential allowing relatively quickly cooked pizzas and relatively slowly cooked pans of chicken wings to be simultaneously cooked within the oven at a single conveyor cycling speed setting.

In a suitable embodiment where a longitudinal auxiliary baking chamber is provided, an oppositely longitudinal auxiliary baking chamber is additionally provided at the oppositely longitudinal end of the conveyor tunnel oven. Such oppositely longitudinal auxiliary baking chambers is preferably mirroringly configured with respect to the longitudinal auxiliary baking chamber.

In the suitable embodiment, a longitudinal plurality of auxiliary baking chambers is additionally provided, such baking chamber plurality including the at least first longitudinal auxiliary baking chamber described above. The longitudinal plurality of auxiliary baking chambers comprises at least a second auxiliary baking chamber, such chambers preferably being laterally adjacent to each other. Where such longitudinal plurality of auxiliary baking chambers if provided, the first chamber among such plurality preferably has a longitudinal dimension which exceeds that of the second chamber among such plurality. Such differential in longitudinal dimensions advantageously allows an operator to alter the effective baking time experienced by a food item by selectively placing the food item upon the conveyor either at the entrance of the first chamber among such plurality or at the entrance of the second chamber among such plurality.

Also, in the suitable embodiment, an oppositely longitudinal plurality of auxiliary baking chambers is provided, such plurality being installed at the oven's oppositely longitudinal food output port, and such plurality being mirroringly configured with respect to the longitudinal plurality of auxiliary baking chambers.

The instant inventive conveyor tunnel oven preferably further comprises longitudinal and oppositely longitudinal mounting means which are adapted for securely mounting the longitudinal and oppositely longitudinal pluralities of auxiliary baking chambers respectively upon the longitudinal and oppositely longitudinal end walls of the baking chamber. In the preferred embodiment, such mounting means position the auxiliary baking chambers so that their interior spaces communicate with the food intake and food output ports. In such embodiment, the mounting means cantilever the longitudinal and oppositely longitudinal auxiliary baking chambers respectively longitudinally and oppositely longitudinally from the end walls of the baking chamber, such cantilevering extensions allowing such auxiliary baking chambers to respectively overlie upper surfaces of the longitudinal and oppositely longitudinal outward extensions of the oven's food conveyor without contacting the conveyor.

In a preferred embodiment, the auxiliary baking chamber mounting means comprise plates which are rigidly attached to the ends of such chambers which communicate with the food passage ports. Upon provision of such mounting means, screw fasteners, nut-and-bolt fasteners, or threaded lug and nut fasteners, may be provided for securely attaching the mounting plates and their rigidly supported auxiliary baking chambers to the end walls of the baking chamber. Other commonly known means and mechanisms for attaching the auxiliary baking chambers to the end walls of the oven's main baking chamber, such as directly bolted attachments and slide bracket attachments, are considered to fall within the scope of the invention.

The instant inventive conveyor tunnel oven may further comprise or incorporate specialized modifications of the oven's impingement air channeling finger ducts. Impingement air emitting finger ducts which are commonly mounted within conventionally known and conventionally configured tunnel conveyor ovens commonly configure their air jetting outlet ports to avoid or minimize emissions of heated baking case air from the oven's food intake and outlet ports. In such conventionally known air impingement tunnel conveyor ovens, such conventional finger duct configurations promote the oven's cooking efficiency by avoiding outward spillage of heated cooking air.

The instant invention recognizes that the installations of the auxiliary baking chambers at the oven's food intake and output ports similarly operate to avoid spillage of heated cooking air at such ports along the lateral dimensions of the auxiliary chambers. Accordingly, the instant invention's auxiliary baking chambers lessen the need for cooking air retaining adaptations of the oven's air jets at or near the junctures of the food intake and output ports and the auxiliary baking chambers. The instant invention takes advantage of such lessened need for cooking air retaining air jet adaptions by oppositely configuring the air jets to oppositely direct and jet cooking air out of the food passage ports and into the interior spaces of the auxiliary cooking chambers. By configuring the jets of the oven's food port adjacent finger ducts to outwardly direct flows of the cooking air, the instant invention advantageously raises temperatures at the interiors auxiliary baking chambers without causing any excessive spillage of cooking air.

In use of the instant inventive conveyor tunnel oven, an operator of the oven may, for example, set the conveyor's cycling speed to match the cooking time needed to properly cook a most quickly cooked food item such as thin crust pizzas. Thereafter, the operator may place an uncooked thin crust pizza upon the upper surface of the longitudinal extension of the food conveyor, such placement situating the uncooked pizza immediately longitudinally from the oven's food intake port. Such placement preferably further situates the pizza laterally or oppositely laterally from and outside of the auxiliary baking chamber. Thereafter, the conveyor tunnel oven may proceed to convey and bake the pizza, applying a proper length of baking time to the pizza.

In the event the operator seeks to utilize the oven for baking a pan of chicken wings, the operator may alternatively place the chicken wing pan at the longitudinal opening at the input end of the auxiliary baking chamber. During the conveyor's carriage of the chicken wing pan through the auxiliary baking chamber, cooking and baking of the chicken wings begins prior to entry of the pan into the oven's larger baking chamber. The effective baking time applied by the inventive oven to the chicken wings is thereby advantageously lengthened without altering the oven's conveyor cycling speed.

Where a plurality of laterally adjacent auxiliary cooking chambers is provided, the operator may further alter the effective cooking time experienced by various food items by selectively placing the food item at an entry of a chosen one of the auxiliary baking chambers among the plurality of provided auxiliary baking chambers.

Accordingly, objects of the instant invention include the provision of a conveyor tunnel oven which incorporates structures as described above, and which arranges those structures in relation to each other in manners described above for the performance of beneficial functions described above. Other and further objects, benefits, and advantages of the instant invention will become known to those skilled in the art upon review of the detailed description which follows, and upon review of the appended drawings.

### BRIEF DESCRIPTION OF THE DRAWINGS

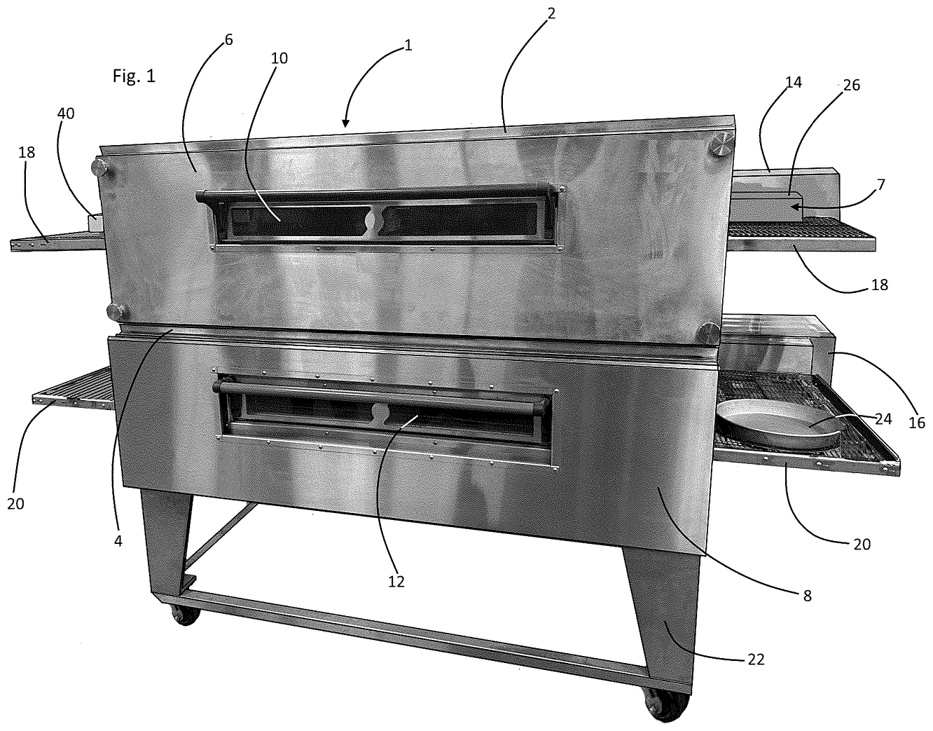

Drawing FIG. 1 is a front view of a stacked pair of air impingement adapted conveyor tunnel ovens, the upper oven including longitudinal and oppositely longitudinal auxiliary baking chambers.

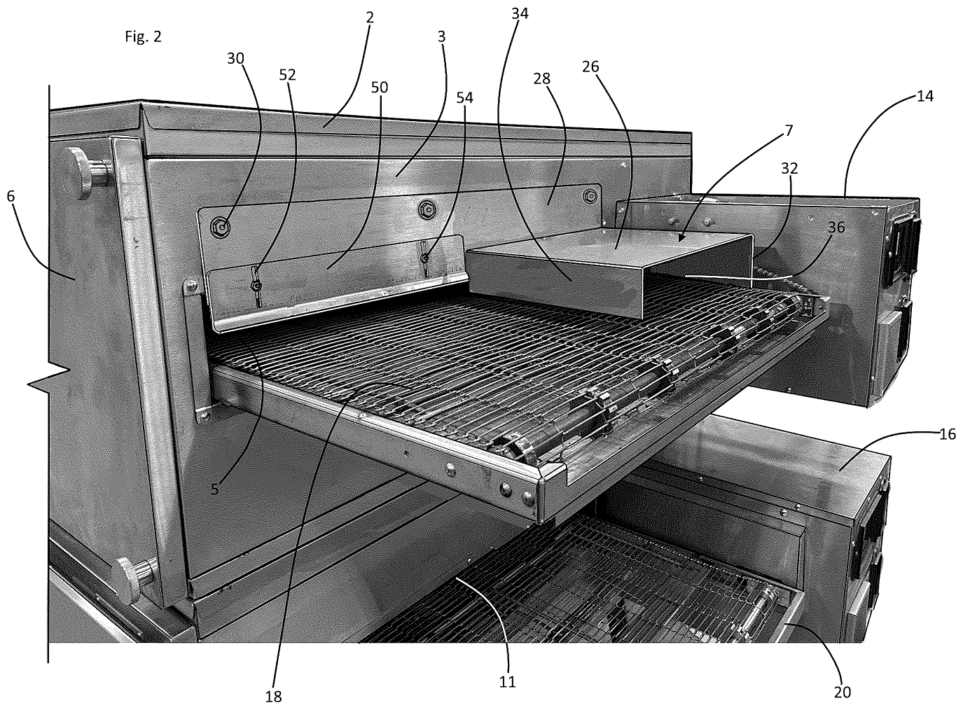

Drawing FIG. 2 is partial perspective view of the longitudinal ends of FIG. 1 ovens.

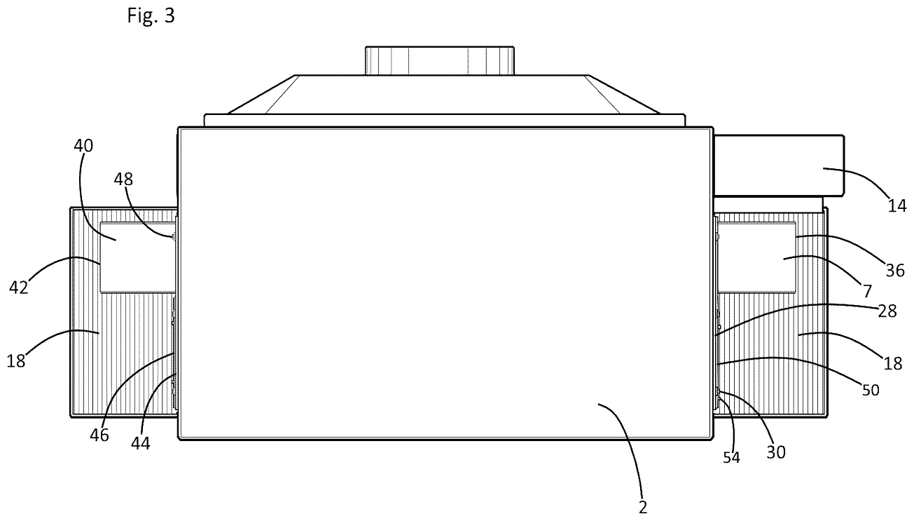

Drawing FIG. 3 is an upper plan view of the oven of FIGS. 1 and 2.

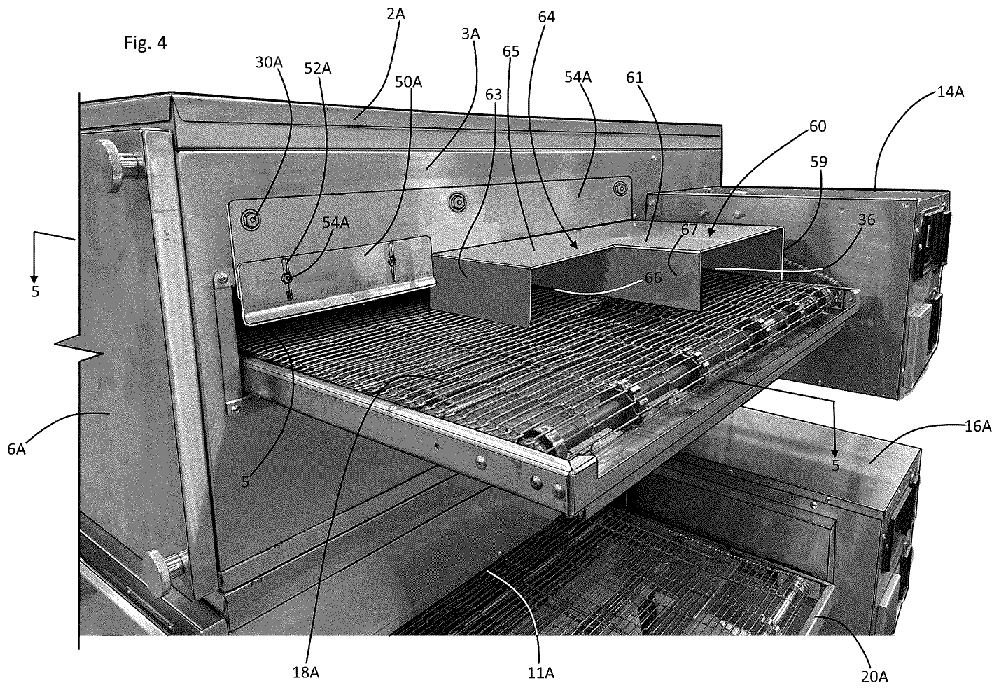

Drawing FIG. 4 redepicts the structure of FIG. 2, the view of FIG. 4 showing an installation of a longitudinal plurality of auxiliary baking chambers.

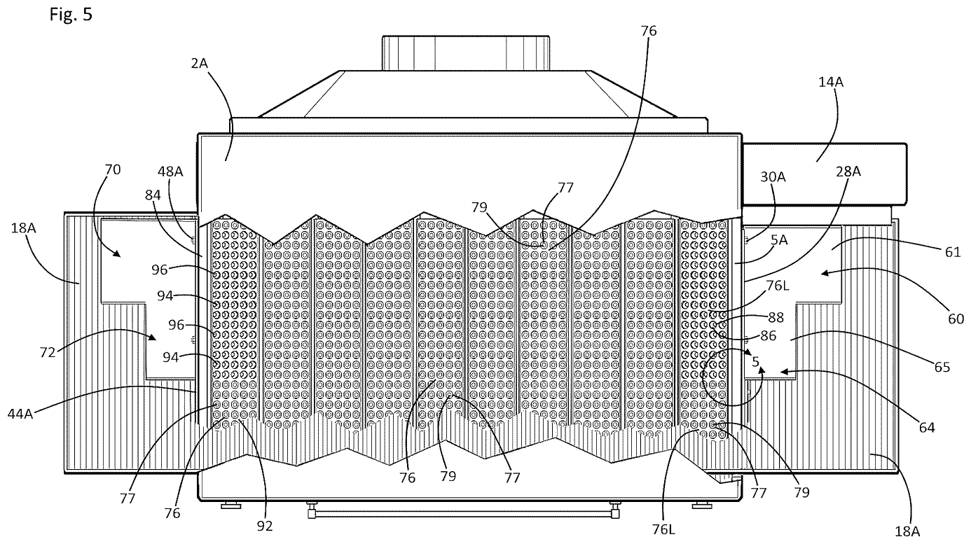

Drawing FIG. 5 is an upper plan view of the oven of FIG. 4, the view of FIG. 5 including cut-away sections of ceiling and conveyor components from the perspective indicated in FIG. 4.

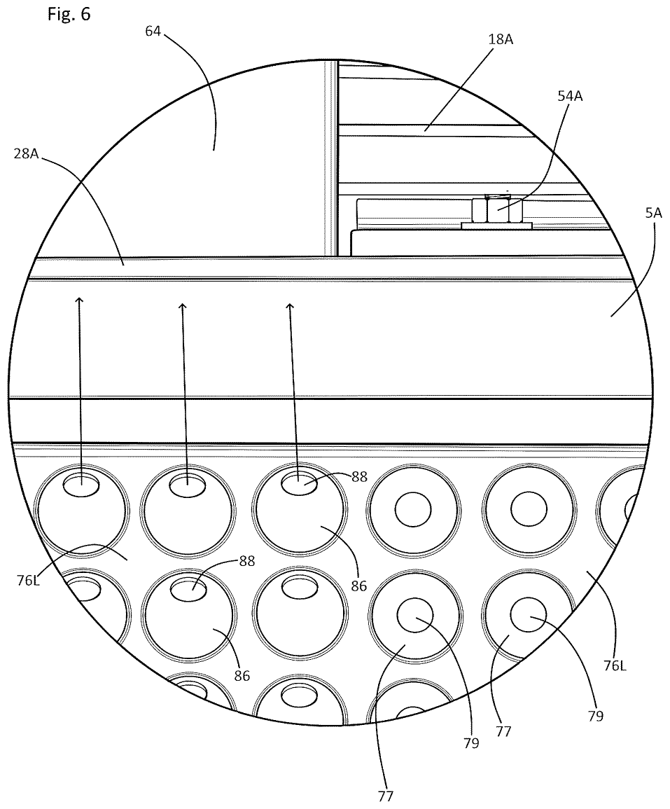

Drawing FIG. 6 is a magnified view of a portion of the structure of FIG. 5, as indicated in FIG. 5.

### DETAILED DESCRIPTION

Referring to FIG. 1, a stacked pair of conveyor tunnel ovens is referred to generally by reference arrow 1. The oven stack 1 includes an upper conveyor tunnel oven 2, and a lower conveyor tunnel oven 4, such ovens commonly including front or lateral wall panels 6 and 8, such panels incorporating pivoting side access doors 10 and 12.

Longitudinal and oppositely longitudinal ends of the ovens, respectively facing rightwardly and leftwardly in the view of FIG. 1, include food item input ports and food item output ports. The ovens' longitudinally opening food item intake ports 5 and 11 are shown in the view of FIG. 2, and mirroring oppositely longitudinal food item output ports (not shown within views) open the ovens' baking chambers at their oppositely longitudinal end walls.

Continuous loop grate type food conveyors 18 and 20 extend longitudinally through the interior spaces or main chambers of the tunnel ovens 2 and 4. Such conveyors 18 and 20 have longitudinal and oppositely longitudinal ends which respectively extend or protrude longitudinally and oppositely longitudinally from the ovens' food item intake and output ports. Control cases 14 and 16 house the ovens' electronic controllers, motor means for driving the conveyors 18 and 20, and gas or electric heating components.

Referring simultaneously to FIGS. 1-3, the upper conveyor tunnel oven 2 has a longitudinal end wall 3 which is opened by the rectangular and laterally oblongated food item intake port 5, the longitudinal end of the food conveyor 18 extending longitudinally from such port. A longitudinal auxiliary baking chamber 7, preferably composed of sheet stainless steel, is formed and defined by an upper wall or ceiling 26, a front or lateral wall 34, and a rear or oppositely lateral wall 32. Such walls advantageously form a downwardly opening and longitudinally extending “C” channel. The oppositely longitudinal end of the longitudinal auxiliary baking chamber 7 is open for communication with the oven's food intake port 5. The open longitudinal end 36 of chamber 7 is similarly open for receiving inputs of food items to be carried oppositely longitudinally through the auxiliary port 7 by the conveyor 18.

One or more of the oppositely longitudinal ends of chamber walls 26, 32, or 34 are rigidly connected to and are supported by a vertical mounting plate 28 which is suitably fastened to the oven's longitudinal end wall 3 by nut and bolt fasteners 30. Such mounting plate 28 supports and holds the longitudinal auxiliary baking chamber 7 in a longitudinal and cantilevering extension which positions the chamber 7 directly above the longitudinal end of the conveyor 18. Such mounting plate 3 is considered to constitute a mounting means component of the invention, and other commonly known types of mechanical fasteners capable of fixedly and removably mounting the longitudinal auxiliary baking chamber 7 upon end wall 3 are considered to fall withing the scope of the invention. For example, slide bracket fasteners may be suitably substituted as the invention's mounting means. Alternatively, screw fasteners may be utilized to secure the auxiliary baking chamber upon the end wall 3.

A substantially mirroring oppositely longitudinal auxiliary baking chamber 40 having an oppositely longitudinal food item output opening 42 is preferably fixedly attached to the oppositely longitudinal end wall of the oven 2. Such second and mirroring auxiliary baking chamber 40 preferably similarly includes a “C” channel forming upper wall, rear wall, and front wall combination. Second or oppositely longitudinal mounting means, preferably comprising a second mounting plate 44, are configured substantially identically with the longitudinal mounting means components 28 and 32, such second mounting means being fastened upon the oven's oppositely longitudinal end wall by nut and bolt fasteners 48.

In use and operation of the instant inventive the conveyor tunnel oven 2 which includes the preferably provided mirroringly installed longitudinal and oppositely longitudinal auxiliary baking chambers 7 and 40, dense and relatively slowly cooked food items such as chicken wings may be initially placed upon and contained within a baking pan or tray 24. The peripheral wall of such baking pan or tray 24 preferably has a vertical height dimension which is less than the vertical distance or elevation between the upper flight of the conveyor 18 and the upper wall 26 of the longitudinal auxiliary baking chamber 7. Such relative sizing of the interior height of the auxiliary baking chamber 7 with respect to the baking pan's height allows the pan and its contents to be carried by the conveyor 18 oppositely longitudinally into and through the longitudinal opening 36, and then through the interior of the auxiliary chamber 7. To initiate such food item passage through the auxiliary chamber 7, the operator may simply place the food containing pan 24 upon the conveyor 18 at a location immediately longitudinally from the chamber opening 36.

The open communication between the oppositely longitudinal end of the longitudinal auxiliary baking chamber 7 and oven's food intake port 5 allows radiant heat and heated air within the interior of baking case 2 emanate into and heat the interior of chamber 7. Such chamber heating advantageously allows baking of food items placed upon the conveyor 18 at the longitudinal opening 36 of the auxiliary chamber to commence prior the food item's passage through input port 5. Cooking times applied by the oven 2 to such food items are therefore advantageously increased by means of the operator's selective placement of the pan at the chamber's entry port 36. Correspondingly, cooking times applied to more quickly cooked food items, such as thin crust pizzas, may be selectively decreased by the operator's placement of pizzas upon the conveyor 18 laterally from and outside of the auxiliary baking chamber 7.

A downwardly extending flange component 50 of the mounting flange 28 preferably has a lower lip or edge which resides at an elevation below the elevation of auxiliary chamber's upper wall 26. In the preferred embodiment, the elevation or upward displacement of such flange's lower edge above the conveyor 18 is less than the corresponding height of the upper wall 26 of the auxiliary baking chamber 7. Such differential in elevations of the flange's lower edge and the auxiliary chamber's upper wall advantageously assures that, upon an erroneous placement of the pan 24 upon the conveyor 18 laterally from the auxiliary baking chamber 7, such pan and the food items contained therein will be blocked from entry into the interior of the baking case 2. Accordingly, the flange 50 functions as a pan entry blocking member which may advantageously prevent undercooked food items from exiting the opposite end of the oven. The operator, upon seeing that the pan 24 has been blocked by flange 50 from entry into the oven, may retrieve the pan, and may correctly place the pan longitudinally from the opening 36 of the auxiliary baking chamber 7.

The blocking flange 50 may suitably comprise an integral or wholly formed downward extension of the lateral end of the mounting plate 28. However, as depicted in FIG. 2, such flange may advantageously comprise the lower end of an alternatively downwardly extendable and upwardly retractable plate. Travel slots 52 and screw and nut fasteners may be provided to facilitate selective vertical positioning of the lower edge of the blocking flange 50. The operator may utilize the fasteners 54 and travel slots 52 to adjust the height of such lower flange edge to reside above the vertical dimension of pizzas carried by the conveyor 18 and to reside below the vertical height of pans which are properly exclusively routed through the auxiliary cooking chambers 7 and 40.

The blocking flange 50 in combination with the relatively higher or taller chamber 7 provides a useful mechanical protection or guard against erroneous placements of such chicken wing bearing pans 24. The instant oven's incorporation of flange 50 may advantageously avoid any erroneously short baking time applied by the oven to relatively dense food items, such as chicken wings, by blocking such erroneously short oven passage. Accordingly, such flange 50 protects against erroneous undercooking of chicken wings while allowing the oven and conveyor to be safely continuously utilized for baking less dense items such as thin crust pizzas.

In a preferred embodiment of the instant inventive oven, the second or oppositely longitudinal auxiliary baking chamber 40 oppositely longitudinally aligns with the first or longitudinal auxiliary baking chamber 7. Provision of such mirroringly installed auxiliary baking chambers advantageously provides needed additional heating and food cooking time at the output end of the conveyor 18.

The instant inventive oven advantageously allows relatively quickly heated and cooked food items, such as thin crust pizzas, to pass through the oven outside of and laterally from chambers 7 and 40. To initiate such relatively short baking time, an operator may place an uncooked pizza upon the conveyor 18 for passage beneath the pan blocking flange 50 rather than passing through chamber 7. Food items which are less quickly heated and cooked, such as chicken wings, may experience the same conveyor transit time during carriage by conveyor 18, with an additional effective baking time during such transit provided by the longitudinal and oppositely longitudinal auxiliary baking chambers 7 and 40. The instant invention advantageously allows an operator to implement increases and decreases of baking times through the simple expedient of selective left versus right placements of food items on the conveyor 18. Fast cooking and slow cooking food items are simultaneously properly cooked by the inventive oven without any alteration of the oven's belt cycling speed.

Fasteners 30 and 48 shown in FIGS. 2 and 3 preferably symmetrically align with and longitudinally mirror each other so that, upon a deinstallation of chamber 7 and mounting plate 28 from the longitudinal end 3 of the oven 2, such chamber and plate may be rotated 180 degrees, and may be reinstalled upon the oven's oppositely longitudinal end. The preferred symmetry of the mounting plates' fasteners 30 and 48 similarly allows the second or oppositely longitudinal mounting plate 44 and it's attached oppositely longitudinal auxiliary baking chamber 40 to be removed and reinstalled upon the longitudinal end of the oven. Such fastener symmetry facilitated interchange of the longitudinal and oppositely longitudinal auxiliary baking chambers 7 and 40 advantageously allows the operator to selectively assign lengthened or shortened effective cooking times to either of the lateral and oppositely lateral sides of the conveyor 18.

While the food item passage blocking flange 46 of the oppositely longitudinal mounting plate 44 is not functionally required while such plate in mounted at the oppositely longitudinal output end of the oven, such flange 46 is needed upon such end-to-end interchange of the auxiliary baking chambers 7 and 40. Accordingly, it is preferred that the auxiliary baking chamber and mounting plate combinations, 7, 28 and 40, 44, mirroringly identically include blocking flanges 50 and 46.

Referring simultaneously to all figures, structures appearing in FIGS. 4-6 which are identified by a reference numeral having a suffix “A” are configured similarly with similarly numbered structures appearing in FIGS. 1-3. In the FIGS. 4-6 structural alternative, a plurality of longitudinal auxiliary baking chambers is provided, such plurality of chambers being represented by auxiliary baking chamber 60 and an adjacent auxiliary baking chamber 64. The longitudinal auxiliary baking chambers may suitably incorporate ceilings 61 and 65 which comprise a laterally continuous span of sheet steel. The respective lateral and oppositely lateral walls of the longitudinal auxiliary baking chambers 60 and 64 may comprise a common wall 67 which, in combination with a lateral wall 63 completes a lateral “C” channel food passage space within auxiliary baking chamber 64, and which, in combination with an oppositely lateral wall 59 completes an adjacent oppositely lateral “C” channel food passage space within auxiliary baking chamber 60.

The longitudinal dimensions of the auxiliary baking chambers 60 and 64 preferably differ from each other, their length differential advantageously allowing an operator to selectively place a food item upon the conveyor 18A either at the entry 62 of chamber 60 or at the entry 66 of chamber 64. A selected placement of the food item at the entry 62 of chamber 60 provides a longest effective cooking time, and an alternative placement of the food item at entry 66 of chamber 64 provides an intermediate cooking time. A further alternative placement of the food item immediately longitudinally from blocking flange 50A may facilitate the operator's decision to apply a shortest effective cooking time to the food item, such placement initially situating the food item immediately laterally from the lateral wall 63 of auxiliary chamber 64.

As shown in FIG. 5, a longitudinally mirroring oppositely lateral plurality of auxiliary baking chambers 70 and 72 may be mounted at the oppositely lateral end of the oven 2A, such oppositely lateral chambers functioning similarly with the single oppositely lateral chamber 40 depicted in FIG. 3. In the preferred embodiment, the oppositely lateral baking chambers 70 and 72 are laterally positioned and arranged to respectively longitudinally align with the longitudinal auxiliary baking chambers 60 and 64.

Referring to FIGS. 5 and 6, a plurality of air impingement finger ducts 76 extend into and are operatively mounted within the interior of baking case 2A, such ducts extending from and being supported by an air plenum (not depicted within views) which is mounted at the oppositely lateral end or rear end of the oven's baking chamber. An electric motor driven fan (not depicted within views) is mounted at an intake port of such air plenum, such fan drawing heated cooking air from the interior of the oven's baking chamber and driving such air through the air plenum and into the finger ducts 76. Air received by the finger ducts 76 emits at a multiplicity of air jets 77 which open the finger ducts.

The finger ducts 76 depicted in FIG. 5 immediately underlie the conveyor 18A, and the air jets 77 of such ducts direct heated cooking air upwardly through the conveyor 18A to impinge against the undersurfaces of food items carried by the conveyor. Accordingly, the finger ducts 76 depicted in FIG. 5 constitute the oven's lower finger ducts. Conveyor tunnel ovens of the type depicted in FIGS. 1-6 commonly additionally include mirroringly configured upper finger ducts (not depicted within views) whose air jets simultaneously direct heated cooking air downwardly for impingement against upper surfaces of the conveyor carried food items.

The multiplicity of air jets 77 are formed as upward protrusions or protuberances within the sheet metal ceilings or output registers of the finger ducts 76. Such air jets 77 include centrally positioned eyes or apertures 79 which direct streams of air upwardly toward and through the conveyor 18A.

Each of the air jets 77 comprises an eyed protuberance which extends or bulges upwardly from one of the finger ducts' upper register plates. In the example of FIG. 6, such protuberances are substantially spherical. Notwithstanding, the eyed protuberances formed within the finger ducts' register plates may be differently geometrically configured, the eyed protuberances having, for example, oval shapes or “V” ridge shapes.

The oven's longitudinally extending array of finger ducts includes a longitudinal-most lower finger duct 80 which is adjacent to the oven's longitudinal food intake port 5A. Correspondingly at the opposite end of the oven, the finger duct array includes an oppositely longitudinal-most lower finger duct 92 which is adjacent to the oven's food output port 84.

Each of the food passage port adjacent lower finger ducts 80 and 92 is opened by a multiplicity of eyed protuberances. Among such protuberance multiplicities, a plurality of eyed protuberances 86 opens the longitudinal-most lower finger duct 80, such eyed protuberances being positioned in longitudinal alignments with the oppositely longitudinal openings of the longitudinal auxiliary baking chambers 60 and 64.

Each of such eyed protuberances 86 has a longitudinal side or end and has an oppositely longitudinal side or end, and in each such protuberance the eye 88 is preferably skewed or angled toward the protuberance's longitudinal side. The longitudinal skews of the eyes 88 of the auxiliary chamber aligned protuberances 86 advantageously directs heated cooking air emitting from the eyes 88 in an upwardly and longitudinally directed trajectory which causes heated air to pass through the conveyor 18A and into the oppositely longitudinal openings of the longitudinal auxiliary baking chambers 60 and 64. Such air directed into the auxiliary chambers 60 and 64 beneficially raises the temperature within those chambers, accelerating baking of food items passing oppositely longitudinally therethrough.

An oppositely longitudinal-most lower finger duct 92 which resides at the oppositely longitudinal end of the oven is mirroringly adjacent the oven's food output port 84. Similarly with the longitudinal-most lower finger duct 80, such oppositely longitudinal-most lower finger duct 92 includes a multiplicity of eyed protuberances, such protuberance multiplicity including a plurality of eyed protuberances 94 whose eyes are angled or skewed in the oppositely longitudinal direction. Mirroring longitudinal alignments of such oppositely longitudinal plurality of eyed protuberances 94 with the longitudinal openings of the oppositely longitudinal auxiliary baking chambers 70 and 72 advantageously allows jets of heated cooking air emitting from the oppositely longitudinally angled eyes 96 to flow into such chambers 70 and 72, correspondingly accelerating food item baking within those chambers.

The longitudinal-most and oppositely longitudinal-most finger ducts of a vertically mirroring array of finger ducts (such array overlying conveyor 18A and not shown within views) may similarly and mirroringly include auxiliary baking chamber aligned protuberances whose eyes are outwardly angled to further direct flows of heated cooking air into the food passage port junctures of the auxiliary baking chambers 60, 64, 70, and 72.

While the principles of the invention have been made clear in the above illustrative embodiment, those skilled in the art may make modifications to the structure, arrangement, portions, components, and method steps of the invention without departing from those principles. Accordingly, it is intended that the description and drawings be interpreted as illustrative and not in the limiting sense, and that the invention be given a scope commensurate with the appended claims.

1. A conveyor tunnel oven comprising:
a. a baking chamber having a longitudinal end and an oppositely longitudinal end;
b. a food item intake port and a food item output port, said ports respectively opening the baking chamber at the baking chamber's longitudinal and oppositely longitudinal ends;
c. a food conveyor extending through the baking chamber, the food conveyor having a longitudinal end extending longitudinally from the food item intake port, and the food conveyor having an oppositely longitudinally end extending oppositely longitudinally from the food item output port;
d. a longitudinal plurality of auxiliary baking chambers comprising a first longitudinal auxiliary baking chamber, and at least a second longitudinal auxiliary baking, the first longitudinal auxiliary baking chamber having a longitudinal dimension greater than that of the at least second longitudinal auxiliary baking chamber; and
e. longitudinal mounting means attaching the longitudinal plurality of auxiliary baking chambers to the baking chamber, the longitudinal mounting means positioning the longitudinal plurality of auxiliary baking chambers over the food conveyor's longitudinal end.

2. The conveyor tunnel oven of claim 1, further comprising an oppositely longitudinal plurality of auxiliary baking chambers and oppositely longitudinal mounting means attaching the oppositely longitudinal plurality of auxiliary baking chambers to the baking chamber, the oppositely longitudinal mounting means positioning the oppositely longitudinal plurality of auxiliary baking chambers over the conveyor's oppositely longitudinal end.

3. The conveyor tunnel oven of claim 2, wherein each baking chamber among the longitudinal plurality of baking chambers cantilevers from the baking chamber's longitudinal end, and wherein each baking chamber among the oppositely longitudinal plurality of baking chambers oppositely cantilevers from the baking chamber's oppositely longitudinal end.

4. The conveyor tunnel oven of claim 3, wherein each baking chamber among the longitudinal and oppositely longitudinal pluralities of auxiliary baking chambers comprises a downwardly opening “C” channel.

5. The conveyor tunnel oven of claim 4, wherein each baking chamber among the longitudinal plurality of auxiliary baking chambers has an interior which communicates with the food intake port, and wherein each baking chamber among the oppositely longitudinal plurality of auxiliary baking chambers has an interior which communicates with the food output port.

6. The conveyor tunnel oven of claim 5, wherein each mounting means among the longitudinal and oppositely longitudinal mounting means comprises a mounting plate, wherein said each mounting mean's mounting plate is rigidly attached to one of the auxiliary baking chambers, and wherein said each mounting mean's mounting plate is removably attached to one of the baking chamber's ends.

7. The conveyor tunnel oven of claim 6, wherein the longitudinal mounting means' mounting plate comprises a food item blocking flange.

8. The conveyor tunnel oven of claim 7, wherein the food item blocking flange has a lower edge, wherein one of the auxiliary baking chambers among the longitudinal plurality of auxiliary baking chambers comprises an upper wall, wherein said lower edge is upwardly displaced from the food conveyor, wherein said upper wall is upwardly displaced from the food conveyor, and wherein said lower edge upward displacement is less than said upper wall upper displacement.

9. A baking time adjusting adaptor for attachment to a conveyor tunnel oven, the conveyor tunnel oven having a longitudinal of food passage port, the conveyor tunnel oven having an oppositely longitudinal food passage port, the baking time adjusting adaptor comprising:
a. a longitudinal mounting plate adapted for removable attachment to the conveyor tunnel oven above the longitudinal the food passage port; and
b. a plurality of longitudinal auxiliary baking chambers fixedly attached to and cantilevering longitudinally from the longitudinal mounting plate.

10. The baking time adjusting adaptor of claim 9, further comprising a food item blocking flange fixedly attached to and extending downwardly from the longitudinal mounting plate.

11. The baking time adjusting adaptor of claim 10, wherein one of the baking chambers among the longitudinal plurality of baking chambers has an upper wall, and wherein the food item blocking flange has a lower edge residing at an elevation below that of said upper wall.

12. The baking time adjusting adaptor of claim 11, comprising an oppositely longitudinal mounting plate adapted for removable attachment above the oppositely longitudinal food passage port, and further comprising an oppositely longitudinal plurality of auxiliary baking chambers fixedly attached to and cantilevering from the oppositely longitudinal mounting plate.

13. The adaptor of claim 12, wherein the cantilevered extensions of the longitudinal and oppositely longitudinal pluralities of auxiliary baking chambers are directed oppositely from each other.

14. A conveyor tunnel oven comprising:
a. a baking chamber having a longitudinal end and an oppositely longitudinal end;
b. a food item intake port and a food item output port, said ports respectively opening the baking chamber at the longitudinal and oppositely longitudinal ends;
c. a food conveyor extending through the baking chamber, the food conveyor having a longitudinal end extending longitudinally from the food item intake port, the food conveyor having an oppositely longitudinally end extending oppositely longitudinally from the food item output port;
d. a longitudinal auxiliary baking chamber;
e. longitudinal mounting means attaching the longitudinal auxiliary baking chamber to the baking chamber's longitudinal end, the longitudinal mounting means positioning the longitudinal auxiliary baking chamber over the food conveyor's longitudinal end;
f. a longitudinal air duct mounted within the baking chamber;
g. a longitudinal multiplicity of ports, each port among the longitudinal multiplicity of ports opening the longitudinal air duct; and
h. a longitudinal plurality of ports, each port among the longitudinal plurality of ports comprising one of the ports among the longitudinal multiplicity of ports, said each port among the plurality of longitudinal ports being adapted for directing a flow of air toward the longitudinal auxiliary baking chamber.

15. The conveyor tunnel oven of claim 14, comprising:
a. an oppositely longitudinal auxiliary baking chamber;
b. oppositely longitudinal mounting means attaching the oppositely longitudinal auxiliary baking chamber to the baking chamber's oppositely longitudinal end, the oppositely longitudinal mounting means positioning the oppositely longitudinal auxiliary baking chamber over the food conveyor's oppositely longitudinal end;
c. an oppositely longitudinal air duct mounted within the baking chamber;
d. an oppositely longitudinal multiplicity of ports, each port among the oppositely longitudinal multiplicity of ports opening the oppositely longitudinal air duct; and
e. an oppositely longitudinal plurality of ports, each port among the oppositely longitudinal plurality of ports comprising one of the ports among the oppositely longitudinal multiplicity of ports, said each port among the oppositely longitudinal plurality of ports being adapted for directing another flow of air toward the oppositely longitudinal auxiliary baking chamber.

16. The conveyor tunnel oven of claim 15 wherein each port among the longitudinal plurality of ports is laterally aligned with the longitudinal auxiliary baking chamber.

17. The conveyor tunnel oven of claim 16 wherein each port among the oppositely longitudinal plurality of ports is laterally aligned with the oppositely longitudinal auxiliary baking chamber.

18. The conveyor tunnel oven of claim 17 wherein each port among the longitudinal plurality of ports comprises an eyed protuberance having a longitudinal side and an oppositely longitudinal side, and wherein such protuberance's eye opens at said longitudinal side.

19. The conveyor tunnel oven of claim 17 wherein each port among the oppositely longitudinal plurality of ports comprises an eyed protuberance having a longitudinal side and an oppositely longitudinal side, and wherein such protuberance's eye opens at said oppositely longitudinal side.
